(19) United States
(12) Patent Application Publication
(10) Pub. No.: US 2012/0213320 A1
(43) Pub. Date: Aug. 23, 2012

(54) DEVICE FOR ASSISTING IN THE UNDERWATER EXTRACTION OR INSERTION OF AN ELONGATE ELEMENT DISPOSED IN A PIPE, AND METHOD FOR ASSISTING IN THE EXTRACTION OR INSERTION OF ONE SUCH ELEMENT

(75) Inventors: Frederic Lange, Chatillon (FR); Jacques Floquet, Visan (FR); Gerard Murat, Lyon (FR)

(73) Assignee: AREVA NP, Courbevoie (FR)

(21) Appl. No.: 13/496,393

(22) PCT Filed: Sep. 15, 2010
(86) PCT No.: PCT/FR10/51913

§ 371 Date: May 9, 2012

(30) Foreign Application Priority Data
Sep. 16, 2009 (FR) 09 56354

(51) Int. Cl. G21C 19/105; G21C 17/00

(52) U.S. Cl. 376/245

(57) ABSTRACT

A device for assisting in the underwater extraction or insertion of an elongate element disposed in a pipe is provided. The device includes a clamping and vibration-generating assembly including a sealed housing bearing a gripper and including a member for tightening the gripper on the pipe, an adjustable vibrator for vibrating the housing and the gripper, and a member for measuring the vibration produced by the vibrator on the pipe in order to determine the optimum vibration The device also includes a controller for remotely controlling the gripper and the vibrator. A method for assisting in the extraction or insertion of an elongate element is also provided.

The present invention relates to a device for assisting in the underwater extraction or insertion of an elongate element disposed in a pipe, and in particular a thermocouple disposed in a measuring pipe for the upper internal equipment of a pressurized water nuclear reactor.

The invention also relates to a method for assisting in the underwater extraction or insertion of an elongate element disposed in a pipe.

### BACKGROUND

Pressurized water nuclear reactors comprise, inside a vat, the core of the nuclear reactor made up of fuel assemblies having a prismatic shape with their vertical axis and, above the core, upper internal equipment in particular comprising a set of vertical guide-tubes making it possible to ensure the guiding of the control rods formed by bundles of rods placed parallel to one another and containing a material absorbing neutrons.

To control the reactors by adjusting the reactivity of the core, the clusters of absorber rods are moved in the vertical direction, during operation of the reactor, so that the absorber rods are introduced over a greater or lesser height inside certain fuel assemblies of the core.

The upper internal equipment generally comprises an upper plate, also called support plate, and a lower plate constituting the upper plate of the core of the nuclear reactor bearing on the upper end of the fuel assemblies, when the upper internal equipment is in the service position in the core of the reactor. The vertical guide-tubes guiding the control rods are connected to the support plate and the lower plate, which each comprise a first part inserted between the support plate and the lower plate and a second part fastened above said support plate. Support columns disposed between the support plate and the lower plate, parallel to the guide-tubes, make it possible to maintain these plates and ensure the rigidity of the upper internal equipment.

The upper internal equipment also comprises instrument columns, such as cylindrical thermocouple columns. Arranged in each of the thermocouple columns is a set of thermocouples making it possible to measure the temperature of the coolant at the outlet of a preselected set of fuel assemblies of the core of the reactor.

There are generally from two or four thermocouple columns.

Each thermocouple column is not fastened on the support plate of the upper internal equipment, but is guided by a spindle extending vertically above said plate and penetrating the thermocouple column. However, each thermocouple column is made integral with the cover of the vat of the reactor only by upper sealing means, disposed between a tubing of an adapter secured in an opening of the cover and the upper part of the column.

Several thermocouples are therefore disposed in a column and leave that column through peripheral openings, formed at the base of the column to each rejoin a bleed passing through the support plate. To that end, each bleed is provided with a guide tube positioned aligned with an opening formed in the support plate substantially overhanging a zone where the temperature measurement must be done. The thermocouple is introduced into an upper guide pipe supported by the thermocouple column and by a lower guide pipe disposed in the tube of the corresponding bleed. The sensitive measuring end of the thermocouple is positioned at the predetermined measuring zone.

Part of the thermocouples is intended to measure the temperature of the coolant of the reactor, at the outlet of the core, below the upper plate of the core, near the upper tip of the fuel assemblies.

The thermocouples introduced into the pipes are subject to high temperature and pressure stresses, with the result that some of them may have operating defects after a certain residence time in the vat of the reactor.

Thus, it is no longer possible to have a reliable and representative image of the actual temperature of the coolant of the core of the reactor.

It is therefore necessary to replace these thermocouples during scheduled maintenance operations of the nuclear reactor.

The replacement of the thermocouples is done after stopping and cooling the reactor and after disassembling the cover.

Before disassembling the cover, the connections of the thermocouples are disconnected and the control rods of the corresponding absorber clusters are separated. The upper internal equipment of the reactor is disassembled and placed in a storage area in the pool of the reactor.

To extract the defective thermocouples, one pulls, from the upper level of the pool, remotely and underwater, on the thermocouple using a tool engaged with the extension of the thermocouple outside the corresponding column. It may be necessary to exert very strong pulling on the thermocouple to remove it.

In fact, because the thermocouple is mounted with very little, and even practically no play in certain parts of the pipes, the frictional forces, during removal of the thermocouples, can be very significant.

In certain cases, the thermocouple is blocked in the pipe and cannot be removed by pulling without risk of rupture. In this case, the measuring pipe is lost, which causes the loss of a measuring point.

In certain long pipes with several curves, it is fairly unlikely that it will be possible to remove the thermocouple, the gripping being sufficient to create a blocking situation.

In other cases, despite successful pulling, it can be difficult or even impossible to introduce a new thermocouple into the pipe.

Lastly, simple pulling on the thermocouple can lead to damage to the wall of the corresponding pipe, which is detrimental to the insertion of a new thermocouple.

It is known to facilitate the removal of the thermocouples by propagating ultrasounds in the thermocouple from its end, on which a pulling force is exerted in its axial direction.

However, in the case of thermocouples whereof the blocking part is situated in the lower end of the pipe, i.e. at a significant distance from the thermocouple on which the pulling is exerted and through which the ultrasounds are transmitted, this known method is ineffective.

### SUMMARY OF THE INVENTION

An object of the invention is to provide a device and method for assisting in the extraction or insertion of an elongate element disposed in a pipe that makes it possible, through easy-to-use means, to avoid these drawbacks and facilitate the extraction or insertion of the elongate element.

A device for assisting in the underwater extraction or insertion of an elongate element disposed in a pipe and in particular a thermocouple disposed in a measuring pipe of the upper internal equipment of a pressurized water nuclear reactor is provided. The devices includes a clamping and vibration-generating assembly comprising a sealed housing bearing a gripper and including a member for tightening the gripper on the pipe, an adjustable vibrator for vibrating the housing and the gripper, and a member for measuring the vibration produced by the vibrator on the pipe in order to determine the optimum vibration and, on the other hand, a controller for remotely controlling the gripper and the vibrator.

Embodiments of the invention may include other features:

the gripper comprises a stationary jaw and a movable jaw that can be moved by a clamping member between a position close to the stationary jaw and a position spaced away from said stationary jaw,

the clamping member is formed by a cylinder,

the vibrator is a pneumatic vibrator,

the measuring member is formed by an accelerometer, and

the housing is fastened at the end of a remote handling pole.

A method for assisting in the underwater extraction of an elongate element disposed in a pipe and in particular a thermocouple disposed in a measuring pipe of the upper internal equipment of a pressurized water nuclear reactor, using an extraction device as previously defined, is also provided. The method includes:

the housing is lowered into the water using the handling pole,

the jaws of the gripper are kept in the spaced-apart position,

the jaws of the gripper are placed on either side of the pipe of the elongate element to be extracted,

the clamping member is controlled remotely to move the jaws in the clamping position of the pipe,

the vibrator is commanded to vibrate the pipe using the housing and the gripper,

the vibration created by the vibrator on the pipe is measured to determine the optimum vibration,

the vibrator is adjusted to the optimum vibration, and

pulling is simultaneously exerted in the axial direction on the elongate element.

A method for assisting in the underwater insertion of an elongate element disposed in a pipe and in particular a thermocouple disposed in a measuring pipe of the upper internal equipment of a pressurized water nuclear reactor, using an insertion device as previously defined, is also provided. The method includes:

the housing is lowered into the water using the handling pole,

the jaws of the gripper are kept in the spaced-apart position,

the jaws of the gripper are placed on either side of the pipe of the elongate element to be inserted,

the clamping member is controlled remotely to move the jaws in the clamping position of the pipe,

the vibrator is commanded to vibrate the pipe using the gripper,

the vibration created by the vibrator on the pipe is measured to determine the optimum vibration,

the vibrator is adjusted to the optimum vibration, and

thrust is simultaneously exerted in the axial direction on the elongate element.

### BRIEF SUMMARY OF THE DRAWINGS

The invention will be better understood upon reading the following description, provided as an example and done in reference to the appended drawings, in which:

FIG. 1 is a diagrammatic cross-sectional view through a vertical plane of symmetry of a vat of a pressurized water nuclear reactor,

FIG. 2 is a diagrammatic partial perspective view of the upper internal equipment of a nuclear reactor in position on an operating stand in the pool of the reactor, for an operation to replace at least one thermocouple using the assistance device, according to the invention,

FIG. 3 is a diagrammatic side view of a clamping and vibration-generating assembly of the assistance device, according to the invention,

FIG. 4 is a diagrammatic perspective view of the clamping and vibration-generating assembly of the assistance device according to the invention, and

FIG. 5 is a diagrammatic perspective view of an alternative of the clamping and vibration-generating assembly of the assistance device according to the invention.

### DETAILED DESCRIPTION

In the following description, the device according to embodiments of the invention will be described to assist in the extraction or insertion of an elongate element formed by a thermocouple disposed in a measuring pipe of the upper internal equipment of a pressurized water nuclear reactor.

This device can be used to assist with the extraction or insertion of any other elongate element in a pipe.

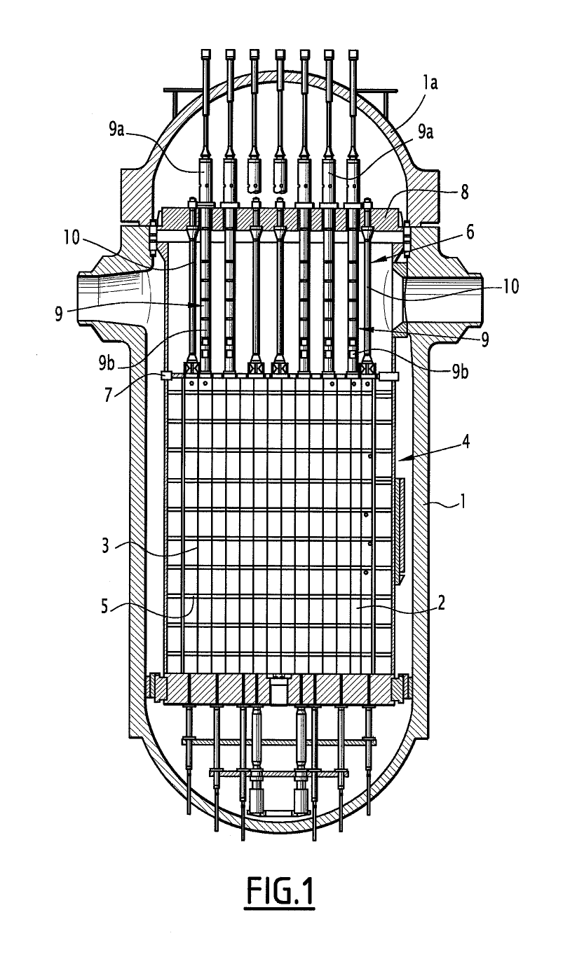

FIG. 1 diagrammatically illustrates a vat of a pressurized water nuclear reactor designated by reference 1. Traditionally, disposed inside the vat 1 of the nuclear reactor is the core 2 formed by fuel assemblies 3 juxtaposed so that the longitudinal axis of the fuel assemblies is vertical. The core 2 of the reactor is disposed inside lower internal equipment designated by general reference 4 and in particular comprising the partition 5 of the core.

The nuclear reactor also comprises upper internal equipment designated by general reference 6 that rests on the upper plate of the assemblies of the core, via an upper core plate 7.

As shown in FIG. 1, the upper internal equipment 6 comprises a support plate 8 of the guide-tubes that will hereafter be called support plate 8. This support plate 8 extends parallel to the upper core plate 7 constituting the lower portion of the upper internal equipment 6 and which is made so as to ensure fastening of the upper internal equipment 6 inside the vat 1.

The upper internal equipment 6 comprises the guide-tubes designated by general reference 9, which are made up, each above the support plate 8, of an upper portion 9a with a circular section and, between the support plate 8 of the upper internal equipment 6 and the upper core plate 7, a lower portion 9b with a generally substantially square cross-section with rounded corners. Each of the parts 9a and 9b constitutes a guide-tube 9 of the upper internal equipment 6 making it possible to move a cluster in the vertical direction to adjust the reactivity in the core of the nuclear reactor, connected to a suspension and movement rod, the vertical movement of which is ensured by a mechanism, not shown, situated above the cover 1a of the vat 1.

Placed between the support plate 8 of the upper internal equipment 6 and the upper core plate 7, in addition to the lower parts 9b of the guide-tubes 9, are bracing columns 10 ensuring the maintenance and spacing of the upper core plate 7 relative to the support plate 8.

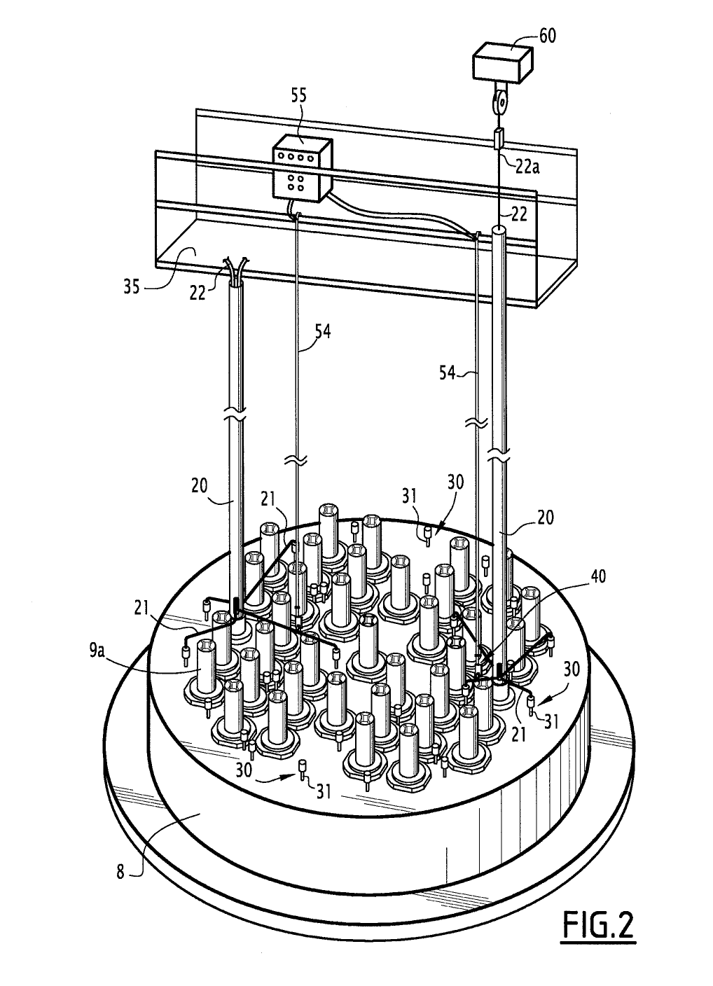

FIG. 2 shows, diagrammatically and in perspective view, the upper surface of the support plate 8 that supports the upper parts 9a of the guide-tubes 9 and in the embodiment shown in that figure, two thermocouple columns 20 that extend parallel to the guide-tubes 9, above the support plate 8. Traditionally, disposed in each of the thermocouple columns 20 is a set of upper guide pipes 21 each of a thermocouple 22 making it possible to measure the temperature of the coolant at the outlet of a preselected assembly set of the core of the nuclear reactor.

As shown in FIG. 2, several upper guide pipes 21 are disposed in a column 20 and leave that column through peripheral openings formed above the foot of the thermocouple column 20 to each join a bleed designated by general reference 30 and intended to pass through the support plate 8 of a thermocouple 22.

In this figure, a limited number of the upper pipe 21 has been shown so as not to overload the figure.

After a certain operating time of the nuclear reactor, the reactor is stopped and cooled for maintenance and to reload with fuel assemblies.

To perform the maintenance and repair operations for this internal equipment of the vat of the reactor, the cover is removed after cooling the reactor and the upper internal equipment 6 can be removed from the reactor and placed in a storage area in the pool of the reactor. In the event one or more thermocouples 22 used to measure the temperature of the coolant at the outlet of the core have become defective during use, they must be replaced. This operation to replace the thermocouples is done on the upper internal equipment disposed in its storage area and requires that the defective thermocouple 22 first be extracted from that pipe 21, and that a new thermocouple 22 be inserted in that pipe 21.

The extraction or insertion of a thermocouple 22 in the corresponding pipe 21 is facilitated by the assistance device, according to the invention, and which comprises a clamping and vibration-generating assembly of the corresponding pipe 21, this assembly being designated by general reference 40 in FIGS. 2 to 5.

As shown in FIG. 2, to place the clamping and vibration-generating assembly on the pipe 21 of the thermocouple 22 to be extracted or inserted, the operators work from a bridge 35 placed above the upper level of the water in the pool in which the upper internal equipment is disposed.

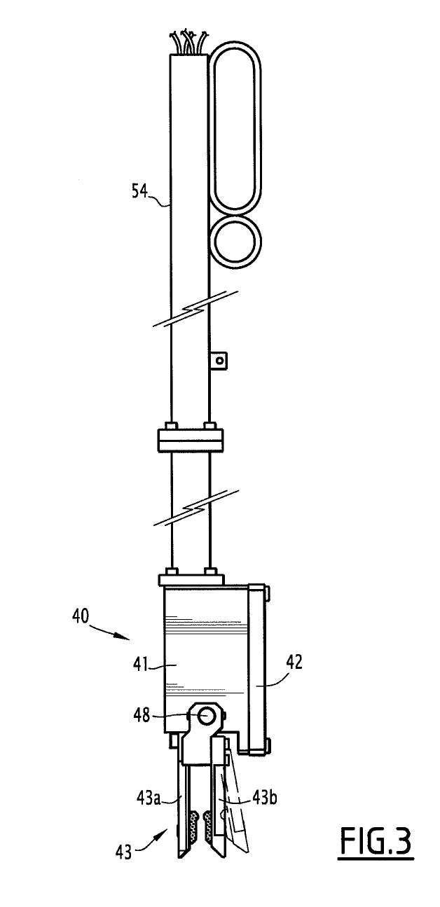

As shown more particularly in FIGS. 3 to 5, the assembly 40 comprises a sealed housing 41 equipped, on one of its surfaces, with a removable cover 42. The housing 41 is mounted at the end of a pole 54, thereby allowing operators to work from the bridge 35 and to bring the housing 41 close to the pipe 21 of the thermocouple 22 to be extracted or inserted.

The sealed housing 41 bears a gripper 43 made from two jaws, 43a and 43b, respectively, extending, in the clamping position, substantially parallel to one another. These jaws 43a and 43b each bear a pad, for example made from plastic, on the surface intended to be in contact with the pipe 21.

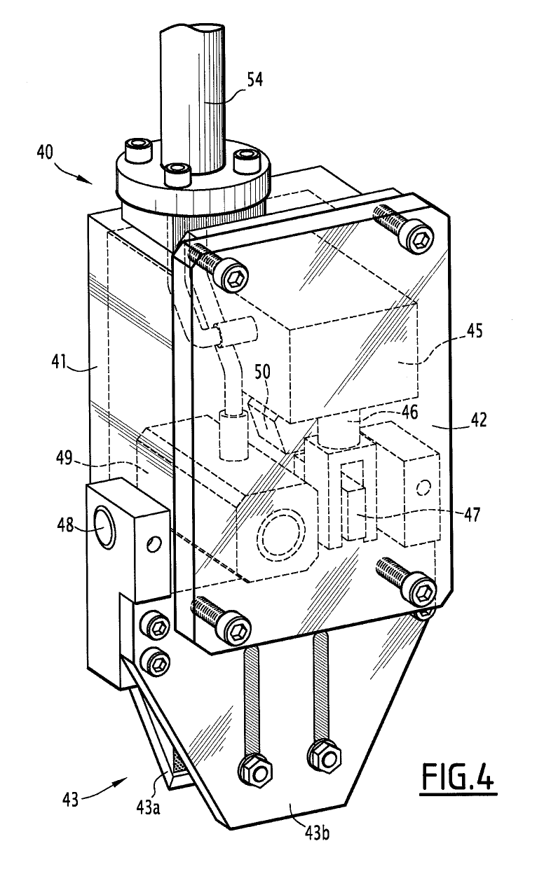

In the embodiment illustrated in FIGS. 3 to 5, the jaw 43a is stationary and the jaw 43b is mobile. The mobile jaw 43b can be moved by a clamping member 45 disposed inside the housing 41 (FIG. 4) between a position close to the stationary jaw 43a to clamp the conduit 21 and a position spaced away from said stationary jaw 43a shown in broken lines in FIG. 3 so as to allow the gripper 43 to be positioned on the pipe 21 or to allow the removal of that gripper 43.

The clamping member 45 is preferably formed by a cylinder. This cylinder 45, for example pneumatic, traditionally comprises a piston 46 that acts on a handling yoke 47 of the mobile jaw 43b. To that end, the yoke 47 is connected to a transverse axis 48 that bears the mobile jaw 43b.

The mobile jaw 43b is kept in position spaced away from the stationary jaw 43 for example by a spring (not shown), or by any other suitable member.

The housing 41 of the assembly 40 generally contains an adjustable vibrator 49, for example pneumatic and of a known type, that makes it possible to vibrate said housing 41 and the gripper 43 supported by said housing 41.

Lastly, the housing 41 contains a measuring member 50 for measuring the vibration created by the vibrator 49 on the pipe 21 to determine the optimum vibration for the pipe 21 so as to enable the extraction or insertion of the thermocouple 22 in that pipe 21. This measuring member 50 is formed by an accelerometer or any other suitable element.

The cylinder 45, the vibrator 49 and the accelerometer 50 are connected by electric and pneumatic connections to a controller in the form of a control and monitoring cabinet 55 mounted on the bridge 35. These electric and pneumatic connecting elements pass inside the handling pole 54. This handling pole 54 is formed from several elements mounted successively to form a sealed pole.

In the case of an extraction of a defective thermocouple 22, the free end 22a of said thermocouple 22 protruding relative to the column 20 is connected, as shown in FIG. 2, to a pulling device 60 of said thermocouple 22 for example made up of a hoist.

In the case of an insertion of a new thermocouple 22 in the corresponding pipe 21, the free end 22a protruding relative to the column 20 is connected to a thrust device on said thermocouple 22.

To extract a thermocouple 22 that is stuck in its pipe 21, the operators placed on the bridge 35 proceed as follows.

First, the operators connect the free end 22a of the thermocouple 22 to be extracted to the hoist 60, as shown in FIG. 2.

Next, the operators lower the housing 41 of the assembly 40 into the water of the pool using the handling pole 54. The jaws 43a and 43b of the gripper 43 are kept in the spaced apart position, thereby allowing the operators to place the pipe 21 of the thermocouple 22 to be extracted between said jaws, 43a and 43b, respectively. The operators can be helped by a viewing device, for example such as an underwater camera placed at the bottom of a handling pole.

Using the control cabinet 55, the operators remotely control the cylinder 45 so as to move the mobile jaw 43b and bring the gripper 43 into a clamping position via the piston 46 of the cylinder 45, which acts on the yoke 47 so as to pivot the mobile jaw 43b around the transverse axis 48. After clamping the gripper 43 on the pipe 21 of the thermocouple 22 to be extracted, the operators actuate the vibrators 49 to vibrate the pipe 21 via the housing 41 and the gripper 43. The accelerometer 50 measures the vibration created by the vibrator 49 on the pipe 21 and the value thus measured is displayed on the control housing 55, thereby making it possible to determine the optimum vibration created in the pipe 21. The operators adjust the vibrator 49 to the optimum vibration.

At the same time, the hoist 60 exerts a pulling force in the axial direction on the thermocouple 22 so as to extract it from its pipe 21.

The vibrations thus created in the pipe 21 of the thermocouple 22 to be extracted during the pulling phase make it possible to create micro-delaminations between the thermocouple and the pipe and to reduce the coefficient of friction between said thermocouple and said pipe. In this way, the potential damage of the pipe is reduced and the chances of successfully extracting the thermocouple are increased.

According to one alternative, several assemblies 40 can be placed on a same pipe.

According to another alternative, vibrations can also be created in the thermocouple itself In that case, a vibrator, not shown, is mounted in series with the pulling device, i.e. with the hoist 60.

To introduce a new thermocouple 22 into a pipe 21 after extracting a defective thermocouple, the operators proceed in the same way, but instead of pulling on the thermocouple, they use a suitable system to exert thrust on the thermocouple to be introduced into the pipe.

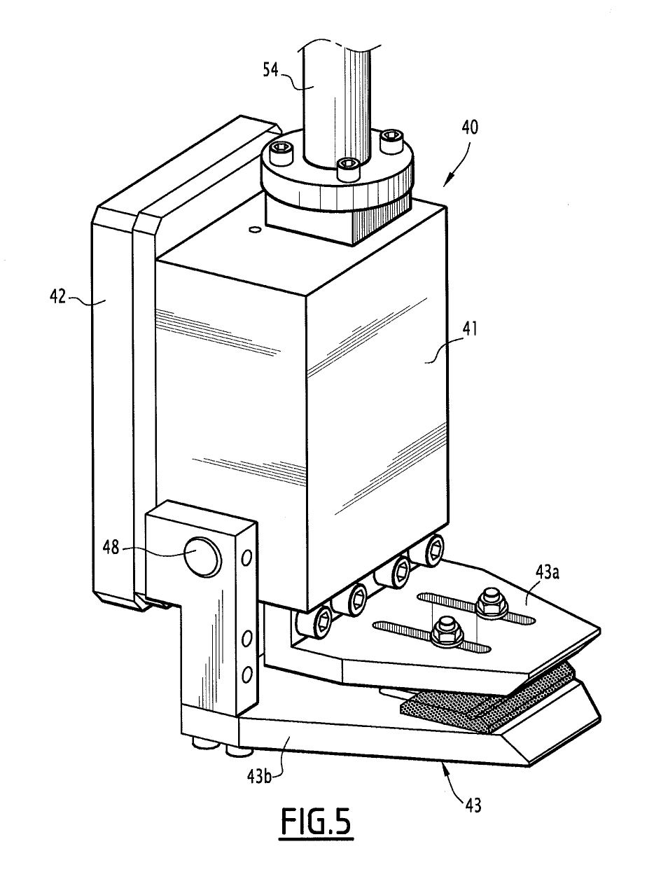

According to another embodiment shown in FIG. 5, the jaws 43a and 43b of the gripper 43 are disposed horizontally, while in the embodiment previously described, these jaws are disposed vertically.

1-10. (canceled)

11. A device for assisting in underwater extraction or insertion of an elongate element disposed in a pipe of a nuclear reactor comprising:
a clamping and vibration-generating assembly including:
a sealed housing bearing a gripper and including a tightener for tightening the gripper on the pipe;
an adjustable vibrator for vibrating the housing and the gripper; and
a measurer for measuring the vibration produced by the vibrator on the pipe to determine an optimum vibration; and
a controller for remotely controlling the gripper and the vibrator.

12. The device as recited in claim 11 wherein the elongate element is a thermocouple and the pipe is a measuring pipe of upper internal equipment of a pressurized water nuclear reactor.

13. The device as recited in claim 11 wherein the gripper includes a stationary jaw and a movable jaw movable by a clamp between a position close to the stationary jaw and a position spaced away from the stationary jaw.

14. The device as recited in claim 13 wherein the clamp is formed by a cylinder.

15. The device as recited in claim 11 wherein the vibrator is a pneumatic vibrator.

16. The device as recited in claim 11 wherein the measurer is formed by an accelerometer.

17. The device as recited in claim 11 wherein the housing is fastened at an end of a remote handling pole.

18. A method for assisting in the underwater extraction of an elongate element disposed in a pipe of a nuclear reactor using the device as recited in claim 11, the method comprising:
lowering the housing into the water using a handling pole, the housing being fastened at an end of the handling pole;
spacing jaws of the gripper apart from each other in a spaced-apart position;
placing the jaws of the gripper on either side of the pipe of the elongate element;
remotely controlling a clamp to move the jaws to a clamping position in which the jaws clamp the pipe;
commanding the vibrator to vibrate the pipe using the gripper;
measuring the vibration created by the vibrator on the pipe to determine the optimum vibration; and
adjusting the vibrator to the optimum vibration and simultaneously pulling the elongate element in an axial direction of the elongate element.

19. The method as recited in claim 18 wherein at the same time as the vibration of the pipe, the elongate element is vibrated and a pulling force is exerted on said elongate element.

20. The method as recited in claim 18 wherein the elongate element is a thermocouple and the pipe is a measuring pipe of upper internal equipment of a pressurized water nuclear reactor.

21. A method for assisting in the underwater insertion of an elongate element disposed in a pipe of a nuclear reactor, using the device as recited in claim 11, the method comprising:
lowering the housing into the water using a handling pole, the housing being fastened at an end of the handling pole;
spacing jaws of the gripper apart from each other in a spaced-apart position;
placing the jaws of the gripper on either side of the pipe of the elongate element to be inserted;
remotely controlling a clamp to move the jaws of the gripper to a clamping position in which the jaws clamp the pipe;
commanding the vibrator to vibrate the pipe using the gripper;
measuring the vibration created by the vibrator on the pipe to determine the optimum vibration; and
adjusting the vibrator to the optimum vibration and simultaneously exerting thrust on the elongate element in an axial direction of the elongate element.

22. The method as recited in claim 21 wherein at the same time as the vibration of the pipe, the elongate element is vibrated and a thrust force is exerted on the elongate element.

23. The method as recited in claim 21 wherein the elongate element is a thermocouple and the pipe is a measuring pipe of upper internal equipment of a pressurized water nuclear reactor.
